(19) United States
(12) Patent Application Publication
(10) Pub. No.: US 2021/0310591 A1
(43) Pub. Date: Oct. 7, 2021

(54) Conduit End Support And Plug Apparatus

(71) Applicant: Samuel Fraga, Toronto (CA)

(72) Inventor: Samuel Fraga, Toronto (CA)

(21) Appl. No.: 16/838,404

(22) Filed: Apr. 2, 2020

(51) Int. Cl. F16L 23/00; F16L 3/127; F16L 55/11

(52) U.S. Cl. CPC F16L 23/003; F16L 55/11; F16L 3/127

(57) ABSTRACT

A conduit end support and plug apparatus for installing conduit in concrete includes a flange having a plurality of mounting apertures to receive fasteners to attach the apparatus to a concrete slab mold. A support body is coupled to the flange to receive a conduit pipe. A base plug has an outer base portion and a central raised plug portion. The central raised plug portion fits within the conduit pipe. A breakable attachment bridge is coupled to the base plug and the flange. The breakable attachment bridge is breakable to separate and remove the base plug from the flange once concrete has hardened in the concrete slab mold.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to conduit installation devices and more particularly pertains to a new conduit installation device for installing conduit in concrete.

### (2) Description of Related Art Including Information Disclosed Under 37 CFR 1.97 and 1.98

The prior art relates to conduit installation devices. Existing devices either serve to support the ends of conduit onto a mold for a concrete slab and create a void around the end of the pipe or to plug the end of the conduit to prevent concrete from entering. What is needed, and what the present invention provides, is a single device to support the ends of the conduit, create a void around the ends, and to prevent concrete from entering the pipe.

### BRIEF SUMMARY OF THE INVENTION

An embodiment of the disclosure meets the needs presented above by generally comprising a flange having a flange top side, a flange bottom side, a flange outer edge, and a flange inner edge. The flange has a plurality of mounting apertures extending from the flange top side through the flange bottom side. The plurality of mounting apertures is configured to receive fasteners to attach the apparatus to a concrete slab mold. A support body is coupled to the flange. A support outer wall of the support body is coupled to the flange top side adjacent the flange inner edge and extends away from the flange top side and a cylindrical support inner wall is configured to receive a conduit pipe. A base plug has an outer base portion and a central raised plug portion. The central raised plug portion is configured to fit within the conduit pipe. A breakable attachment bridge is coupled to the base plug and the flange inner edge. The breakable attachment bridge is breakable to separate and remove the base plug from the flange once concrete has hardened in the concrete slab mold.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a conduit end support and plug apparatus according to an embodiment of the disclosure.

FIG. 2 is a bottom plan view of an embodiment of the disclosure.

FIG. 3 is a side elevation view of an embodiment of the disclosure.

FIG. 4 is a cross-sectional view of an embodiment of the disclosure along the line 4-4 of FIG. 3.

### DETAILED DESCRIPTION OF THE INVENTION

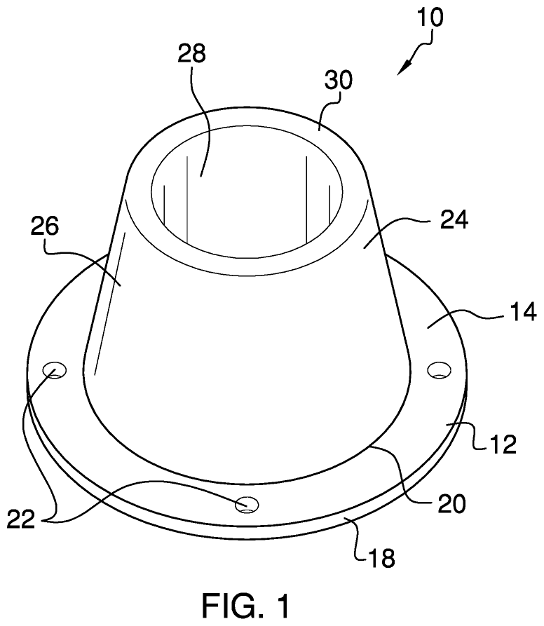

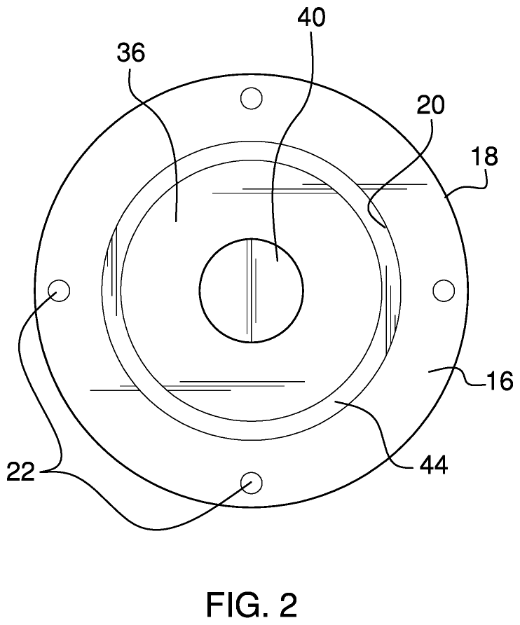

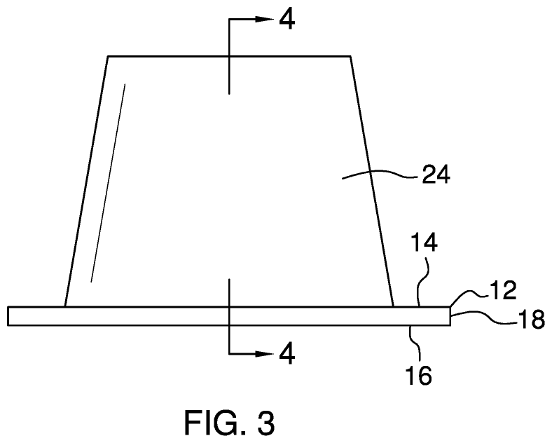

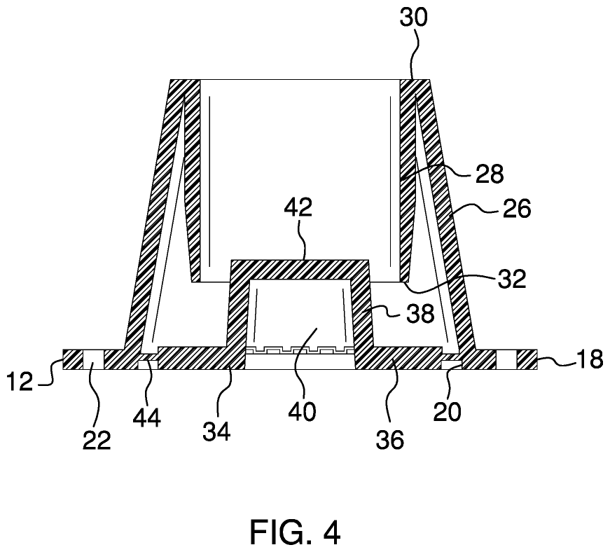

With reference now to the drawings, and in particular to FIGS. 1 through 4 thereof, a new conduit installation device embodying the principles and concepts of an embodiment of the disclosure and generally designated by the reference numeral 10 will be described.

As best illustrated in FIGS. 1 through 4, the conduit end support and plug apparatus 10 generally comprises a flange 12 having a flange top side 14, a flange bottom side 16, a flange outer edge 18, and a flange inner edge 20. The flange 12 has a plurality of mounting apertures 22 extending from the flange top side 14 through the flange bottom side 16 and configured to receive fasteners to attach the apparatus 10 to a concrete slab mold. The plurality of mounting apertures 22 may be a set of four mounting apertures 22 spaced 90° apart around the flange 12.

A support body 24 is coupled to the flange 12. A support outer wall 26 of the support body is coupled to the flange top side 14 adjacent the flange inner edge 20 and extends away from the flange top side 14. A cylindrical support inner wall 28 extends from a support distal end 30 of the support outer wall and is configured to receive a conduit pipe. The diameter of the support inner wall 28 conforms to standard trade sizes of conduit pipe such as, but not limited to, ½″, ¾″, 1″, and 5/4″. An inner bottom end 32 of the support inner wall lies in a plane above a plane of the flange top side 14. The support outer wall 26 may be angled and the support inner wall 28 may be perpendicular to the plane of the flange top side 14 to create a void around the conduit pipe allowing for easier work and attachment. The thickness of the support inner wall 28 may taper thinner towards the inner bottom end 32.

A base plug 34 has an outer base portion 36 and a central raised plug portion 38. The outer base portion 36 may lie coplanar with the flange 12 and has a diameter less than the diameter of the flange inner edge 20. The central raised plug portion 38 may be hollow and may define a plug cavity 40 for manufacturing optimization as well as to provide a place for a user to manipulate the base plug 34. The thickness of the base plug 34 may be equal to the thickness of the flange 12. A plug top side 42 of the central raised plug portion may lie within the support inner wall 28. The central raised plug portion 38 is configured to fit within the conduit pipe and prevent anything from entering.

A breakable attachment bridge 44 is coupled to the base plug 34 and the flange inner edge 20. The thickness of the breakable attachment bridge 44 is less than the thickness of the base plug 34. The breakable attachment bridge 44 may continuously extend between the perimeter of the base plug 34 and the flange inner edge 20 to prevent concreate from entering the apparatus 10. The breakable attachment bridge 44 is breakable to separate and remove the base plug 34 from the flange 12 once concrete has hardened in the concrete slab mold.

In use, the apparatus 10 is fixed to the concrete slab mold with fasteners through the plurality of mounting apertures 22. The conduit pipe is then placed through the support inner wall 28 and around the central raised plug portion 38. Once the concrete has been poured and hardened, the breakable attachment bridge 44 is broken to remove the base plug 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A conduit end support and plug apparatus comprising:
a flange having a flange top side, a flange bottom side, a flange outer edge, and a flange inner edge, the flange having a plurality of mounting apertures extending from the flange top side through the flange bottom side, the plurality of mounting apertures being configured to receive fasteners to attach the apparatus to a concrete slab mold;
a support body coupled to the flange, the support body having a support outer wall coupled to the flange top side adjacent the flange inner edge and extending away from the flange top side and a cylindrical support inner wall configured to receive a conduit pipe;
a base plug having an outer base portion and a central raised plug portion, the central raised plug portion being configured to fit within the conduit pipe; and
a breakable attachment bridge coupled to the base plug and the flange inner edge, the breakable attachment bridge being breakable to separate and remove the base plug from the flange once concrete has hardened in the concrete slab mold.

2. The conduit end support and plug apparatus of claim 1 further comprising the support inner wall extending from a support distal end of the support outer wall, an inner bottom end of the support inner wall lying in a plane above a plane of the flange top side.

3. The conduit end support and plug apparatus of claim 2 further comprising the support outer wall being angled and the support inner wall being perpendicular to the plane of the flange top side.

4. The conduit end support and plug apparatus of claim 2 further comprising the thickness of the support inner wall tapering thinner towards the inner bottom end.

5. The conduit end support and plug apparatus of claim 1 further comprising the thickness of the breakable attachment bridge being less than the thickness of the base plug.

6. The conduit end support and plug apparatus of claim 5 further comprising the thickness of the base plug being equal to the thickness of the flange.

7. The conduit end support and plug apparatus of claim 1 further comprising the outer base portion lying coplanar with the flange.

8. The conduit end support and plug apparatus of claim 1 further comprising the central raised plug portion being hollow and defining a plug cavity.

9. The conduit end support and plug apparatus of claim 1 further comprising a plug top side of the central raised plug portion lying within the support inner wall.

10. A conduit end support and plug apparatus comprising:
a flange having a flange top side, a flange bottom side, a flange outer edge, and a flange inner edge, the flange having a plurality of mounting apertures extending from the flange top side through the flange bottom side, the plurality of mounting apertures being configured to receive fasteners to attach the apparatus to a concrete slab mold;
a support body coupled to the flange, the support body having a support outer wall coupled to the flange top side adjacent the flange inner edge and extending away from the flange top side and a cylindrical support inner wall configured to receive a conduit pipe, the support inner wall extending from a support distal end of the support outer wall, an inner bottom end of the support inner wall lying in a plane above a plane of the flange top side, the support outer wall being angled and the support inner wall being perpendicular to the plane of the flange top side;
a base plug having an outer base portion and a central raised plug portion, the outer base portion lying coplanar with the flange, the central raised plug portion being hollow and defining a plug cavity, the thickness of the base plug being equal to the thickness of the flange, a plug top side of the central raised plug portion lying within the support inner wall, the central raised plug portion being configured to fit within the conduit pipe; and
a breakable attachment bridge coupled to the base plug and the flange inner edge, the thickness of the breakable attachment bridge being less than the thickness of the base plug, the breakable attachment bridge being breakable to separate and remove the base plug from the flange once concrete has hardened in the concrete slab mold.

11. The conduit end support and plug apparatus of claim 10 further comprising the thickness of the support inner wall tapering thinner towards the inner bottom end.
